(19) United States
(12) Patent Application Publication
(10) Pub. No.: US 2004/0206715 A1
(43) Pub. Date: Oct. 21, 2004

(54) DUAL HIGHLINE SYSTEM AND METHOD

(75) Inventor: Jim Rodnunsky, Granada Hills, CA (US)

Correspondence Address: DALINA LAW GROUP, P.C., 7910 IVANHOE AVE. #325, LA JOLLA, CA, 92037, US

(73) Assignee: CABLECAM INTERNATIONAL INC., Granada Hills, CA (US)

(21) Appl. No.: 10/604,667

(22) Filed: Aug. 8, 2003

(51) Int. Cl. B66C 21/00

(52) U.S. Cl. 212/76

(57) ABSTRACT

Embodiments of the invention move objects throughout three-dimensional space. This is accomplished with two highlines which support skates that move along the highlines. The skates support a three sheave device which in turn supports a platform. The entire system is driven in three dimensions by a Y movement rope pair and an XZ movement rope. The Y movement rope pair moves a skate on each highline in the Y-axis direction. The X-axis and Z-axis motion of the platform is controlled by a single XZ movement rope. Increasing the deployed length of the XZ movement rope causes the platform to lower in the Z-axis direction, while decreasing the deployed length of the XZ movement rope causes the platform to rise. For embodiments that employ equal length highlines in a parallel configuration, there is no need for a control system since the Z-axis displacement is independent of X and Y-axis movement. In addition, since the ropes are controlled from one location, distantly located motors and electrical cables are not required. Many types of useful devices may then be attached to the platform including devices that require external power or devices that possess their own power and are operated via wireless signals. Non-parallel and unequal length highline embodiments of the invention may be readily constructed. As the platform traverses X and Y space, Z-axis displacement is dependent upon the distance between the two skates in these embodiments.

### BACKGROUND OF INVENTION

1. Field of the Invention

Embodiments of the invention described herein pertain to the field of aerial cable rail systems. More particularly, these embodiments enable the movement of objects within three-dimensional space.

2. Description of the Related Art

An aerial cable rail system is a system based on an elevated cable or rope, along which objects are transported. Existing cable rail systems have relied on large fixed structures and/or complex control systems in order to facilitate the movement of objects. These systems fail to satisfactorily achieve the full spectrum of ease of control, compact storage, ease of transport, speed, load bearing, volume serviced, extensibility, maintainability and platform stability.

In U.S. Pat. No. 4,625,938, an invention is disclosed in which a camera payload can be moved within three-dimensional space. The invention requires a complex computer control system in order to calculate the vectors and change in lengths of the supports ropes in order to move the payload between two points. Therefore, the invention does not provide simple X, Y and Z independence. In addition, obstacles such as trees or buildings would inhibit the motion of the payload through a path between two points defined within the volume of potential movement, since the wires required to practice the invention travel to the platform directly from the support structures and not from directly overhead.

According to the invention disclosed in U.S. Pat. No. 5,020,443, a highline invention is described which can haul heavy loads, but does not provide quick movement in the X-axis, since large tractors supporting the ends of the highline must be physically relocated. The tension on the highline can vary dramatically depending on obstacles that lie within the path of the vehicles, which can cause the Z-axis of the payload to vary greatly during motion along the X-axis. This invention is impractical for deployment of cameras at sporting events.

In U.S. Pat. No. 5,585,707, an invention is disclosed in which a robot or person can be readily moved within three-dimensional space. The payload is limited and the support structure is small scale. If the structure were to be scaled up, obstacles such as goal posts or light poles would inhibit the motion of the payload through a path between two points defined within the cube, since there are so many wires required to practice the invention. Also, the invention would not appear to allow the Z-axis to vary beneath the cube, and the size of the cube support structure to service a large volume of space would be extremely expensive to build on the scale required.

In U.S. Pat. No. 5,568,189, an invention is disclosed for moving cameras in three-dimensional space. The problems with the '189 invention become apparent when attempting to enlarge the scale of the system. The weight bearing of the invention is dependent upon the strength of the building or structure in which it is mounted and the springs in its weight bearing X-axis connectors. The motors for the various axes are mounted up in the rigging, which would require multiple extremely long power cables to traverse the volume of space along with the payload if the invention were modified for large scale or outdoor use. The power cables would total over 3 times the length of the longest axis to drive the far X-axis motor, the Y-axis motor and the Z-axis motor. Mounting heavy motors high in the rigging presents a major safety issue given that suspension lines can break. The size of the motors limits the payload that can be carried, and further limits the speed at which the payload can be carried. The invention is also fixed in size, not allowing for modular addition of X travel, or increasing the Y or Z-axis travel without mounting the structure in a bigger studio or building a bigger hanger. The patent does not disclose non-parallel or unequal length axis embodiments. See support cable 14 and 16 in FIG. 1. Separate ropes are used for X, Y and Z motion.

In U.S. Pat. No. 6,145,679, an invention is disclosed in which balloons keep the highline aloft, however, one end of the invention is rigid, which would inhibit moving a rescue container or piece of equipment, or log payload to a defined location outside of the pie-shaped space that the invention services. Also, high winds would plague the system as the high surface area of the balloons would render controlled movement inconceivable. Servicing a group of containers at the lower point of the highline requires movement of the containers since the highline is fixed at the lower end.

In U.S. Pat. No. 6,566,834, an invention is disclosed in which a payload can be moved and angularly positioned within three-dimensional space. The invention requires a computer control system in order to calculate the change in lengths of the supports ropes in order to move the pay-load between two points. The invention appears to require power at the platform and locates the winches for the system on the platform, further reducing the payload capacity of the platform. Furthermore, the invention does not provide simple X, Y and Z independence for control purposes and it appears that complex sensing devices must be deployed in order to keep the cables tensioned properly. In addition, obstacles such as trees or buildings would inhibit the motion of the payload through a path between two points defined within the volume of potential movement, since the wires required to practice the invention travel to the platform directly from the support structures and not from directly overhead.

### SUMMARY OF INVENTION

Embodiments of the invention move objects throughout three-dimensional space. This is accomplished with two highlines which support skates that move along the highlines. The skates support a three sheave supporter which in turn supports a platform. The system is driven in three dimensions by a Y movement rope pair and an XZ movement rope. The Y movement rope pair moves a skate on each highline in the Y-axis direction. The X-axis and Z-axis motion of the platform is controlled by a single XZ movement rope. Increasing the deployed length of the XZ movement rope causes the platform to lower in the Z-axis direction, while decreasing the deployed length of the XZ movement rope causes the platform to rise. For embodiments employing equal length highlines in a parallel configuration, there is no need for a control system since the Z-axis displacement is independent of X and Y-axis movement. In addition, since the ropes are controlled from one location, distantly located motors and electrical cables are not required. Many types of useful devices may then be attached to the platform including devices that require external power or devices that possess their own power and are operated via wireless signals. An artisan of ordinary skill will recognize from reading the detailed description that it is feasible to utilize the system to construct non-parallel and unequal length highlines. As the platform traverses X and Y space, Z-axis displacement is dependent upon the distance between the two skates in these non-parallel unequal length highline embodiments.

Creating a three axis movement configuration from Y movement rope pair and a single XZ movement rope driven from a point distantly located from the payload is non-trivial. The advantages are many, including but not limited to allowing the motors to be large, power cables to be short and located near a large generator. In addition, maintenance is readily performed in one location. The XZ rope may also contain a pulley arrangement that multiplies the Z-axis travel.

The system is configured to move objects across any axis by using motors mounted at one support point, on or near the ground, to drive the ropes. These motors connect to a generator that can be as large as the application requires in order to achieve the required payload speed. The sheaves employed in the system may contain high speed bearings and are may be configured to capture the rope in order to prevent derailing in order to add a degree of safety to the system. The drive pulleys attached to the motors comprise grooves that grip the rope in order to prevent slippage. Any known means of driving rope may be substituted for grooved pulleys. A drum winch is used in one or more embodiments of the invention in order to displace XZ movement rope.

For the purposes of this disclosure the use of the word motor signifies a motor connected to a drive pulley or drum winch. This assumption is made for purposes of illustration since it is well known in the art that the motor must drive any of a number of attachments to actually engage rope.

The system can be scaled to any size by employing longer ropes and moving the support structures.

### BRIEF DESCRIPTION OF DRAWINGS

FIG. 1 is a perspective view of the overall system.

FIG. 2 is a logical view of the X, Y and Z-axis reeving.

FIG. 3A is a logical view of the X and Z-axis reeving.

FIG. 3B is a logical view of the Y-axis reeving.

FIG. 4 is a logical view of a parallel embodiment of the system with unequal length highlines.

FIG. 5 is a logical view of a non-parallel embodiment of the system with unequal length highlines.

FIG. 6 is a side view of an embodiment of a three sheave supporter.

FIG. 7 is a side view of an embodiment of a skate.

FIG. 8 is a side view of an embodiment of a platform.

### DETAILED DESCRIPTION

Embodiments of the invention move objects throughout three-dimensional space. This is accomplished with two highlines which support skates that move along the highlines. The skates support a three sheave supporter which in turn supports a platform. The entire system is driven in three dimensions by a Y movement rope pair and an XZ movement rope. The Y movement rope pair moves a skate on each highline in the Y-axis direction. The X-axis and Z-axis motion of the platform is controlled by a single XZ movement rope. Increasing the deployed length of the XZ movement rope causes the platform to lower in the Z-axis direction, while decreasing the deployed length of the XZ movement rope causes the platform to rise. For embodiments that employ equal length highlines in a parallel configuration, there is no need for a control system since the Z-axis displacement is independent of X and Y-axis movement. In addition, since the ropes are controlled from one location, distantly located motors and electrical cables are not required. Many types of useful devices may then be attached to the platform including devices that require external power or devices that possess their own power and are operated via wireless signals. Non-parallel and unequal length highline embodiments of the invention may be readily constructed. As the platform traverses X and Y space, Z-axis displacement is dependent upon the distance between the two skates in these embodiments.

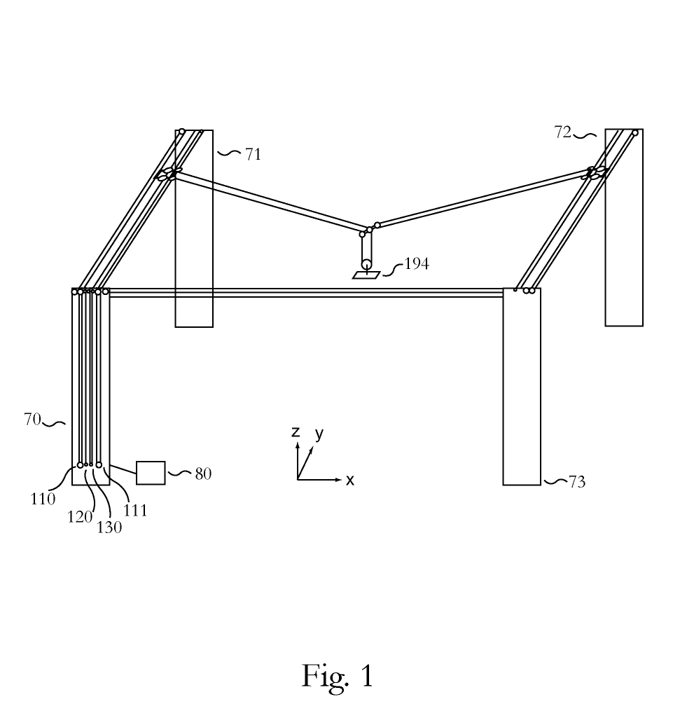

FIG. 1 shows a perspective view of an embodiment of the system. The three axis are shown in the figure with the X-axis shown left to right, the Y-axis shown into the page and the Z-axis shown bottom to top of the page. In this configuration, support structures 70, 71, 72 and 73 separate platform 194 from the ground using various ropes. Embodiments of the invention configured to operate within stadiums may mount sheaves on the stadium itself instead of utilizing separate support structures. Platform 194 provides a mobile attachment point for cameras, mining scoops, logging hooks, or any other utility enabling device applicable to any industry.

Platform 194 is supported by two highlines and is moved in three dimensions by two ropes sets. The ropes in the system are driven by centrally located motors, each with attached drive pulley or drum winch. The drive pulleys and drum winches are not shown in the figures for simplicity. Motors 110 and 111 drive the Y movement rope pair and control the Y-axis positions of platform 194. Motor 120 controls the Z-axis position of platform 194. Motor 130 controls the X-axis position of platform 194. Note that motor 120 drives an end of the XZ movement rope and motor 130 drives XZ movement rope from one side of platform 194 to the other. Generator 80 powers motors 110, 111, 120 and 130. Embodiments of the invention configured with parallel highlines of equal length may employ one motor 110 and couple the drive pulley of unused motor 111 in order to drive Y-axis rope via a pair of coupled drive pulleys. Drive pulleys and drum winches are well known in the art and embodiments that minimize rope wear and provide anti-derailing features may be utilized in the system.

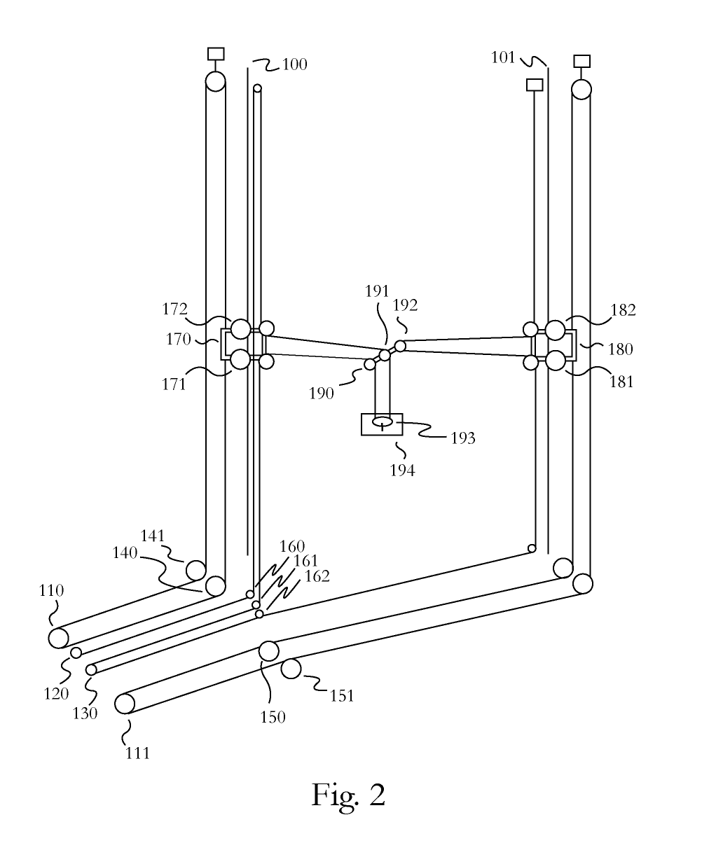

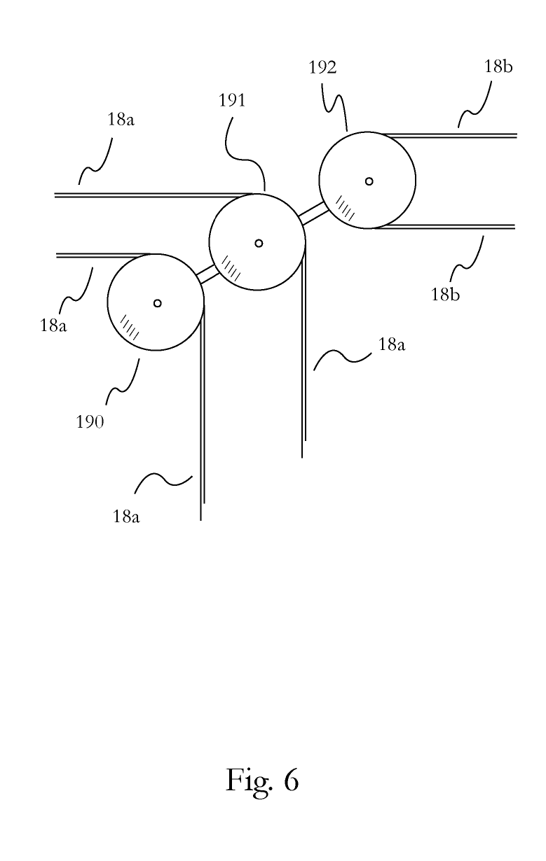

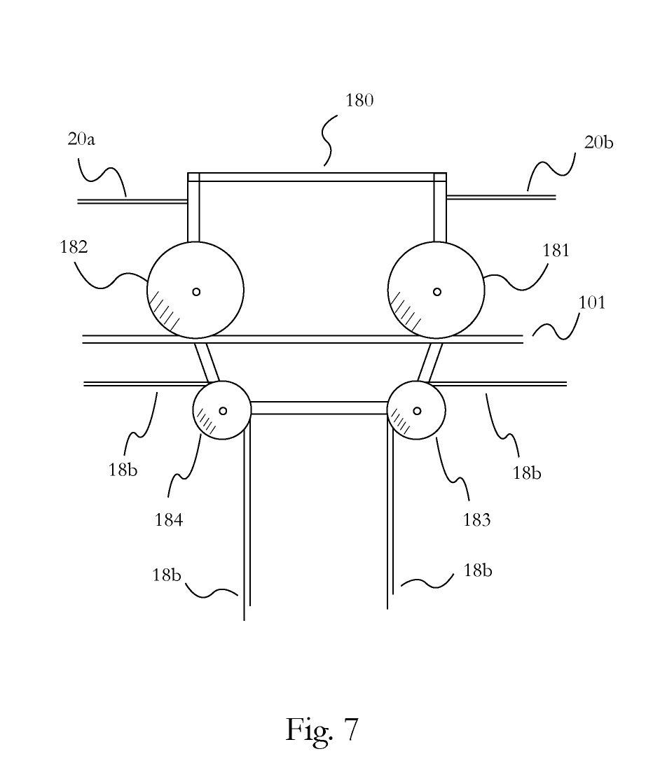

FIG. 2 shows a logical reeving pattern view for both the XZ movement rope and Y movement rope pair. In this figure, motors 110, 111, 120 and 130 are shown in the bottom left portion of the diagram. These motors drive rope up and down support structure 70 as shown in FIG. 1. The ropes are guided to the other support structures via sheaves located in the support structures. Sheaves 140, 141, 150, 151, 160, 161 and 162 guide rope to the required locations. Skate 170 is supported by highline 100 and sheaves 171 and 172 which roll along highline 100 as the skate moves. FIG. 7 shows a close-up of skate 180. Skate 180 is supported by highline 101 and sheaves 181 and 182 which roll along highline 101. As skates 170 and 180 move in the Y-axis direction, sheaves 190, 191 and 192, which are coupled together, move in the Y-axis direction thereby moving platform 194 as well. FIG. 6 shows a close-up of coupled sheaves 190, 191 and 192. Sheaves 190, 191 and 192 freely rotate while the platform moves in the Y-axis direction, but for parallel and equal length highline embodiments, the Z-axis position of platform 194 does not change during Y-axis movement. Platform sheave 193 also freely rotates during Y-axis movement of platform 194 without altering the Z-axis position for the parallel and equal length highline embodiments.

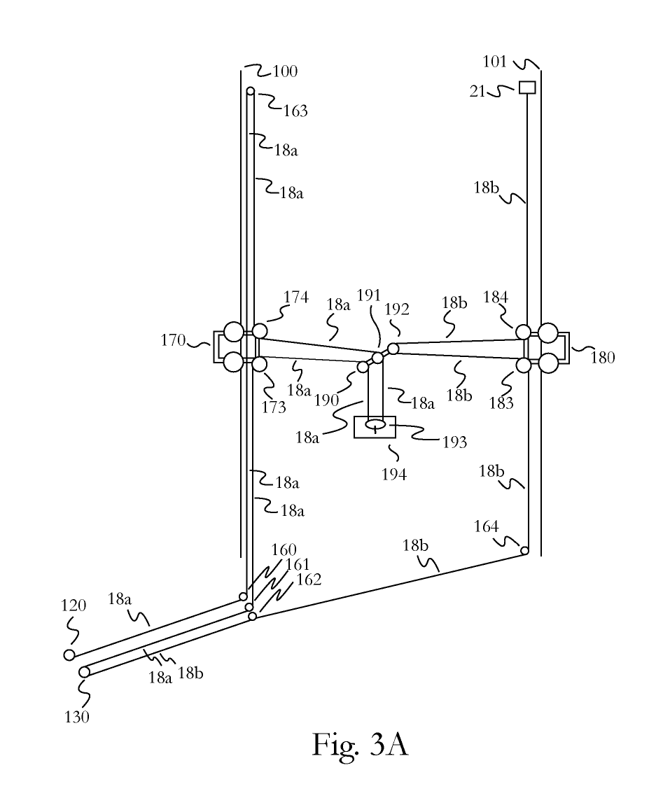

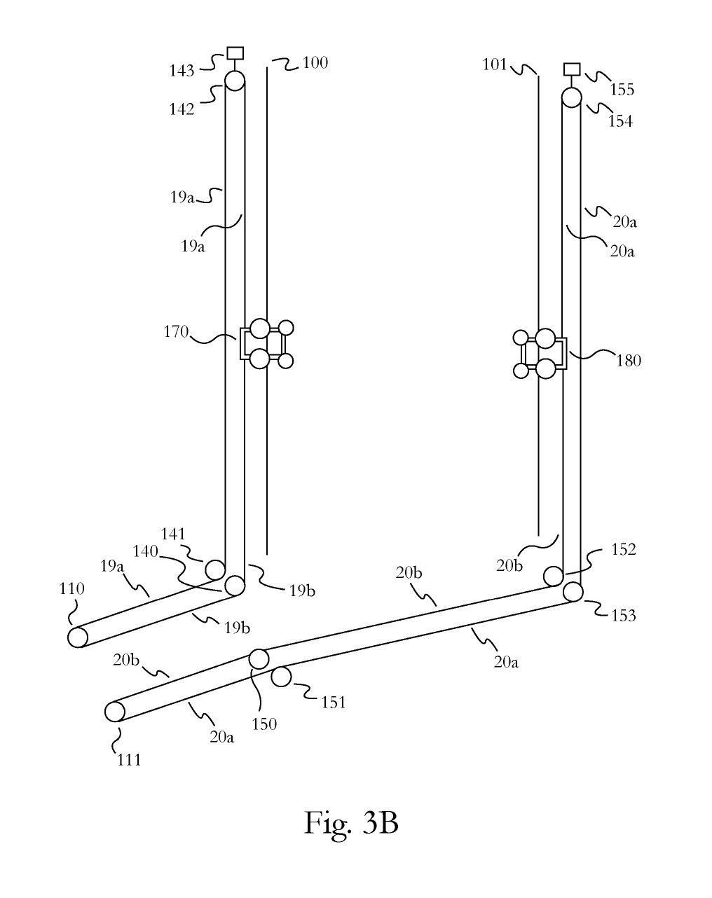

FIG. 3A shows the XZ movement rope reeving pattern. One rope moves the platform in both the X-axis and Z-axis direction. Rope on one side of the motor 130 is designated 18a, while rope on the other side of motor 130 is designated 18b. Therefore, rope 18a and 18b are different sides of the same rope, separated by motor 130. Motor 120 is connected to one end of the XZ movement rope, namely 18a, while tensioner 21 is connected to the other end of the XZ movement rope, namely 18b. Tensioner 21 is used in order to control the tension of the XZ movement rope. A dynamometer may be placed in series with the tensioner or throughout the system in order to measure the tension at various points in the system.

Z-axis movement is provided by motor 120. When Z-axis motor 120 rotates counterclockwise, rope 18a moves upward into sheave 160 to sheave 163 to sheave 174 to sheave 191 to platform sheave 193. As the rope moves into platform sheave 193, the platform lowers. Rotating motor 120 in the opposite direction raises platform 194.

X-axis movement is provided by motor 130. As motor 130 rotates counterclockwise, rope 18a moves down from sheave 161 from sheave 173 from sheave 190 from travels 193 from sheave 191. At the same time, rope 18b travels to sheave 162 to sheave 164 to sheave 183 to sheave 192. This has the effect of moving the three sheave support comprising coupled sheaves 190, 191 and 192 to the left, and hence platform 194 to the left. Rotating motor 130 in the opposite direction moves the platform to the right.

As the platform moves up the Y-axis, equal amounts of XZ movement rope enter sheaves 174 and 184, flow to and from the coupled sheaves 190, 191 and 192, and out of sheaves 173 and 183. Therefore sheaves 173, 174, 183, 184, 190, 191 and 192 spin without altering the X-axis position of the platform when moving in the Y-axis direction.

An embodiment of the invention contains a simple block and tackle fitted between the Z-axis motor 120 and sheave 160 in order to provide a Z-axis N-factor multiplier. This allows a multiplication factor to be calculated by determining the total amount of rope that each side of the block and tackle assembly contains and dividing the amount of rope on the sheave side by the amount of rope extendable from motor 120. For example, if there were two pulleys on the sheave side with corresponding mounted pulley and terminator on the sheave side, and one pulley on the Z-axis motor 120 side, the multiplication factor would be 2. This would allow platform 194 to descend to two times the height of the support structure housing sheave 160. Increasing the number of sheaves looped through on one side or the other of the block alters the multiplication factor accordingly.

FIG. 3B shows the Y movement rope reeving pattern. One pair of ropes moves the platform in the Y-axis direction. Rope on one side of Y-axis motor 110 is designated 19a while rope on the other side of motor 110 is designated 19b. Therefore, rope 19a and 19b are different sides of the same rope. Similarly, rope on one side of motor 111 is designated 20a and on the other side 20b.

For parallel and equal length highline embodiments, motor 110 or motor 111 may be eliminated and the associated drive pulley may be driven by the remaining motor. By rotating Y-axis motor 110 in the counterclockwise direction rope 19b moves into sheave 140 towards skate 170. Rope 19b is attached to skate 170. As the rope moves in this manner, rope from the opposite side of skate 170 moves into sheave 142 to sheave 141 and to motor 110. This has the effect of moving skate 170 in the positive Y direction. Rotating Y movement motor 111 clockwise moves rope 20b up into sheave 150 to sheave 152 to skate 180. As this occurs, rope from the opposite side of skate 180 moves into sheave 154 to sheave 153 to sheave 151 and to motor 111. This has the effect of moving skate 180 in the positive Y direction. Rotating motors 110 and 111 in the opposite direction moves skates 170 and 180 in the negative Y direction.

For parallel and equal length highline embodiments, control of X, Y and Z-axis motors can be in the form of switches to control each motor. For non-parallel and/or unequal length highline configurations a control system may be employed that takes into account the distance between the skates in order to keep platform 194 at the same Z position while traversing the X and Y axis.

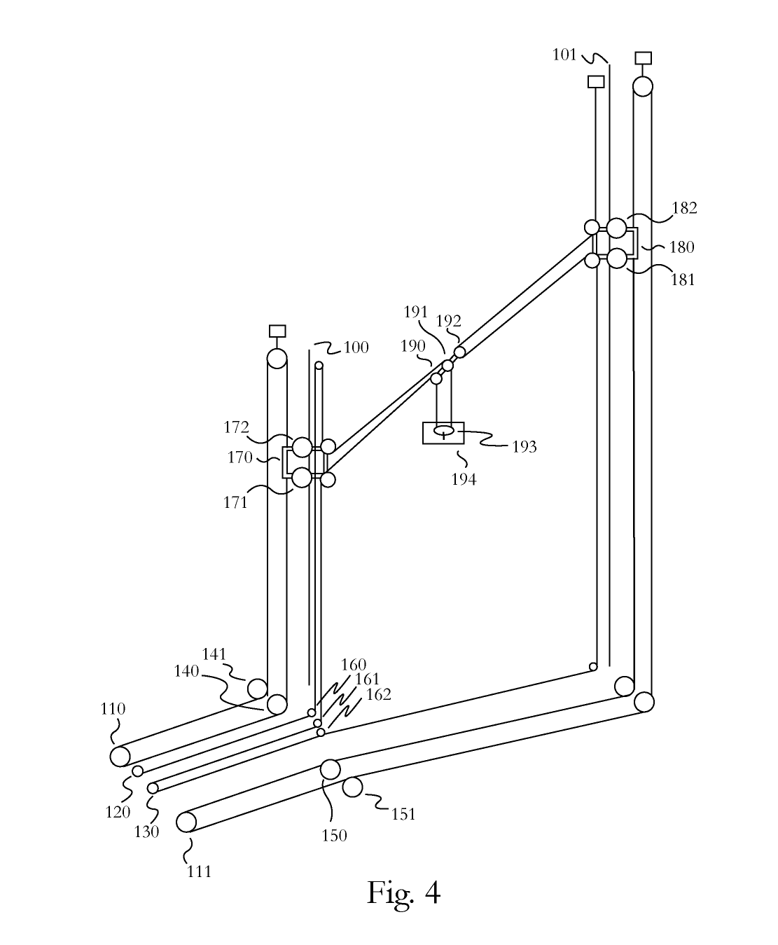

FIG. 4 shows an embodiment of the invention employing highline 101 of twice the length of highline 100, a two to one ratio of movement of motors 111 to 110 would move skate 170 and 180 through their full respective highline ranges. When the skates are the closest together in distance to one another, the Z-axis position of platform 194 is the lowest. Motor 110 or 111 could be eliminated in this embodiment and a 2-to-1 gear ratio could be utilized to drive skate 180 twice as far for every unit of movement of skate 170.

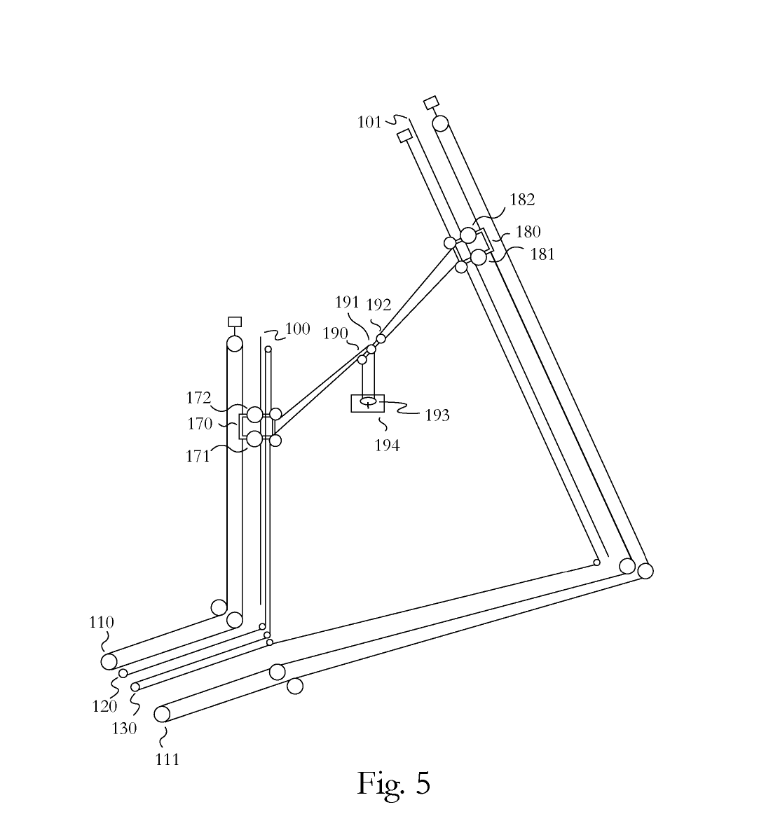

FIG. 5 shows an embodiment employing highline 101 in a non-parallel configuration. As the skates are closest in distance to one another, the Z-axis position of platform 194 is the lowest. Motor 120 may be rotated in the desired direction in order to counteract Z-axis displacement in this embodiment. The rotation of motor 120 may be manual or via a control system that takes into account the distance between the skates.

An embodiment of the invention can run fiber optics cables or power cables along from a generator to skate 170 to platform 194. Platform 194 may alternatively house devices with collocated power supplies negating the need for external power cables. Devices attached to platform 194 may include wireless or other remote controlled devices.

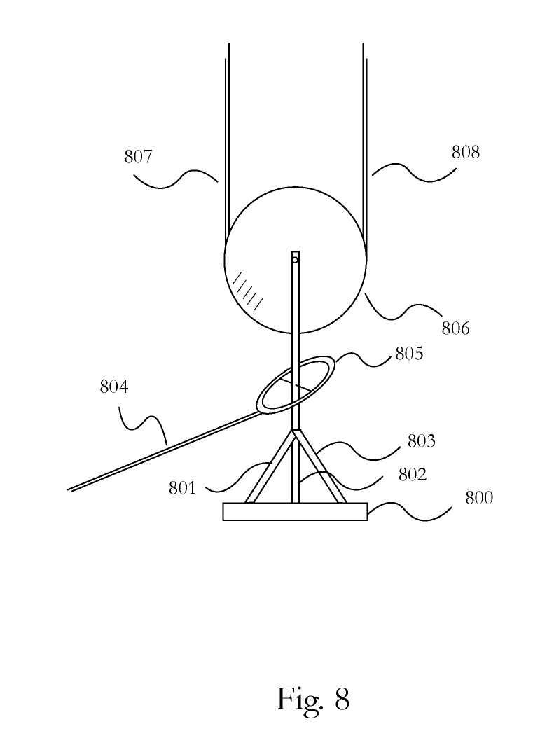

FIG. 8 shows close-up of an embodiment of the platform. Platform 194 is suspended from dampener devices 801, 802 and 803. The dampeners act as stabilizers and may be active or passive in stabilization. In addition, tag line 804 is coupled to a gimbal 805 and provides extra control and stabilization for Y-axis position. Tag line 804 may be vectored to any location within three-dimensional space and may be operated by hand, winch or any other mechanism that winds and unwinds rope. Tag line 804 may be passive, meaning that the length of the tag line does not change as the platform moves, or active, meaning that the tag line is set in motion while moving the platform. Depending on the obstacles that need to be traversed in these higher stability requirement scenarios, the point at which the tag line is pulled from may dynamically change as well in addition to changing the amount of rope dispensed. Generally, the tag line is employed to diminish unwarranted Y-axis movement since X-axis movement is counteracted by opposing skates 170 and 180 in FIG. 3A.

All figures shows embodiments of the invention that use single sheaves at all rope direction points. Other embodiments may use multiple sheave arrangements virtually anywhere where a single sheave is used in order to change direction of a rope and further prevent derailing. Sheaves with groove shapes and rounded edges that minimize the lateral friction on ropes passing through the sheaves may be utilized in order to minimize the amount of wasted power in the system. Embodiments of the invention may use any type of sheave that works with the rope specified for the system. Any linear connection device may be utilized in place of rope, such as but not limited to cable.

Platform 194 can have many different apparatus attached to it to perform a variety of functions including but not limited to stabilization devices, gimbals, camera equipment, mining loaders, mechanical claws for digging and grasping objects, ship-to-ship loaders, logging devices, ski lift seats, gondolas, body sensing flight simulator suits for allowing a person to simulate flying, reduced gravity simulator suits, lifting harnesses, munitions depot bomb retrievers, digital video equipment for security checks in railroad yards or nuclear facilities, robotic agricultural harvest pickers for quickly picking and storing grapes or other produce or any other device that benefits from repeatable placement and motion in three dimensional space. In another embodiment, platform 194 comprises a witness camera mounted pointing down from the platform, providing a picture from the viewpoint of the platform.

Thus embodiments of the invention directed to a Dual Highline Method and System for Moving Objects have been exemplified to one of ordinary skill in the art. The claims, however, and the full scope of any equivalents are what define the metes and bounds of the invention.

What is claimed is:

1. A system comprising:
a first highline;
a second highline;
a first skate coupled to said first highline;
a second skate coupled to said second highline;
a three sheave supporter coupled to said first skate and said second skate;
a platform coupled to said three sheave supporter;
an XZ movement rope configured to move said platform; and,
a Y movement rope pair configured to move said platform.

2. The system of claim 1 further comprising a plurality of sheaves through which said XZ movement rope and said Y movement rope pair travel.

3. The system of claim 1 further comprising:
an X movement motor coupled with said XZ movement rope;
at least one Y movement motor coupled with said Y movement rope pair; and,
a Z movement motor coupled with an end of said XZ movement rope.

4. The system of claim 3 further comprising an electrical generator coupled to said X movement motor and said at least one Y movement motor and said Z movement motor.

5. The system of claim 1 further comprising at least one dynamometer for measuring the tension of said XZ movement rope and said Y movement rope pair.

6. The system of claim 1 further comprising a stabilizer mounted on said platform.

7. The system of claim 1 wherein said platform is coupled with a camera.

8. The system of claim 1 wherein said platform is coupled with a mechanical claw.

9. The system of claim 1 wherein said platform is coupled with a loader.

10. The system of claim 1 wherein said platform is coupled with a mining scoop.

11. The system of claim 1 wherein said platform further comprises a downward pointing camera for remotely viewing from the position of said platform.

12. The system of claim 1 wherein said platform is attached to a flight simulating suit.

13. The system of claim 1 further comprising support structures.

14. A method comprising:
coupling a first skate to a first highline;
coupling a second skate to a second highline;
coupling a three sheave supporter to said first skate and said second skate;
coupling a platform to said three sheave supporter;
configuring an XZ movement rope to move said platform; and,
configuring a Y movement rope pair to move said platform.

15. The method according to claim 14 further comprising:
coupling said XZ movement rope to an X movement motor;
coupling said Y movement rope pair to at least one Y movement motor; and,
coupling said XZ movement rope to a Z movement motor.

16. The method according to claim 15 further comprising:
rotating said X movement motor;
rotating said at least one Y movement motor;
rotating said Z movement motor; and,
moving said platform.

17. A system comprising:
means for coupling a first skate to a first highline;
means for coupling a second skate to a second highline;
means for coupling a three sheave supporter to said first skate and said second skate;
means for coupling a platform to said three sheave supporter;
means for configuring an XZ movement rope to move said platform; and,
means for configuring a Y movement rope pair to move said platform.

18. The system of claim 17 further comprising:
means for coupling said XZ movement rope to an X movement motor;
means for coupling said Y movement rope to at least one Y movement motor; and,
means for coupling said XZ movement rope to a Z movement motor.

19. The system of claim 18 further comprising:
means for rotating said X movement motor;
means for rotating said at least one Y movement motor;
means for rotating said Z movement motor; and,
means for moving said platform.

20. The system of claim 19 further comprising:
means for stabilizing said platform.
